(19) United States
(12) Patent Application Publication
(10) Pub. No.: US 2025/0221387 A1
(43) Pub. Date: Jul. 10, 2025

(54) METHODS AND SYSTEMS FOR DETERMINING A SPATIAL FEED INSERT DISTRIBUTION FOR FEEDING CRUSTACEANS

(71) Applicant: SIGNIFY HOLDING B.V., EINDHOVEN (NL)

(72) Inventors: MATHAN KUMAR GOPALSAMY, MEDFORD, MA (US); PETER DEIXLER, ARLINGTON, MA (US); JAEHAN KOH, CHESTNUT HILL, MA (US); MANUSH PRAGNESHBHAI PATEL, BOSTON, MA (US)

(21) Appl. No.: 18/853,838

(22) PCT Filed: Apr. 3, 2023
(86) PCT No.: PCT/EP2023/058706

§ 371 Date: Oct. 3, 2024

Related U.S. Application Data
(60) Provisional application No. 63/362,603, filed on Apr. 7, 2022.

(30) Foreign Application Priority Data
Apr. 21, 2022 (EP) 22169148.8

(51) Int. Cl. A01K 61/85; A01K 29/00; A01K 61/59; G06T 7/20; G06T 7/70

(52) U.S. Cl. CPC A01K 61/85; A01K 29/005; A01K 61/59; G06T 7/20; G06T 7/70; G06T 2207/10016; G06T 2207/20081; G06T 2207/30241

(57) ABSTRACT

A method is disclosed for determining a spatial feed insert distribution for feeding crustaceans that are present in a volume (4) at least partially enclosed by one or more barriers (6) for keeping the crustaceans (8) in the volume. The method comprises determining an actual spatial distribution of crustaceans within the volume. The method also comprises, based on the determined actual spatial distribution, predicting, for a future time, a future spatial distribution of crustaceans within the volume. The method also comprises determining, based on the future spatial distribution of crustaceans, a spatial feed insert distribution. The spatial feed distribution indicates one or more positions at a boundary of the volume and/or within the volume from which feed is to be inserted in the volume.

### FIELD OF THE INVENTION

This disclosure relates to a method for determining a spatial feed insert distribution for feeding crustaceans, in particular to such method wherein a future spatial distribution of crustaceans is predicted based on a determined actual spatial distribution of crustaceans. This disclosure further relates to a data processing system computer program and computer-readable storage medium for performing such methods. This disclosure also relates to a system for feeding crustaceans.

### BACKGROUND

Aquaculture is crucial to meet the growing demand of food consumption and reduce pressure of nutrient need due to an increase of human population. Among several aquaculture species, crustaceans take up significant amount in the growth of aquaculture, contributing about 9.7% (6.4 million tonnes) in global food.

Shrimp farming, for example, has become attractive as it has some advantageous characteristics: fast growth, low salinity tolerance, and low risk of disease. It has been well documented that crustaceans, in particular shrimps, employ chemosensory to find and reach food. While certain food items rich in amino acids are known to produce best chemotaxis mechanism in shrimps, they are expensive and don't carry sufficient nutrition. As a result, it is a common practice to add small amount of certain chemo-attractants (such as amino acids, fish proteins, vegetable dry mass etc.) to traditional shrimp feed (made out of wheat, corn, soybean etc.) which helps shrimp's chemotaxis mechanism to detect and reach feed. It is common practice that farmers throw in feed pellets into tank/pond at specific times of a day in order to feed the shrimps. Preferably, such feed pellets disintegrate relatively slowly in water so that the pellets can sink to the bottom relatively intact and so that the shrimps have sufficient time to find, pick up and nibble on feed. A longer disintegration time of the feed pellets in principle corresponds to a “longer reach” of the feed pellets meaning that shrimps from farther away from the feed pellets will be able to detect, reach and consume the feed pellets before the pellets are completely disintegrated.

In any case, feed conversion rate (FCR) and survival rate (SR) are among the most important metrics that shrimp farmers strive hard to measure, monitor and improve continuously. Hence, there is a continuous striving in the art for improving systems and methods for feeding crustaceans.

CN 114208746 A discloses a method and system for feeding Japanese prawns which includes generate an intelligent shrimp feeding plan based on growth information of the prawns, therewith improving the technical effect of the shrimp weight gain rate.

WO 2016/023071 A1 discloses an aquatic management system for managing an aquatic ecosystem having a body of water harbouring aquatic animals, the system comprising: a powered vehicle capable of moving within the body of water; a task implementing system connected to the powered vehicle capable of providing information on one or both of a behavioural activity of an aquatic animal and a detrimental environmental condition in the aquatic ecosystem, and implementing a task to enhance the well-being of the aquatic animal, or treat the detrimental condition, based on the information; and a navigation system capable of guiding the powered vehicle to any location or along any path within the body of water for the task implementing system to implement a management task with respect to the aquatic ecosystem.

### SUMMARY

To that end, a method is disclosed for determining a spatial feed insert distribution for feeding crustaceans that are present in a volume at least partially enclosed by one or more barriers for keeping the crustaceans in the volume. The method comprises determining an actual spatial distribution of crustaceans within the volume. The method also comprises, based on the determined actual spatial distribution, predicting, for a future time, a future spatial distribution of crustaceans within the volume. The method also comprises determining, based on the future spatial distribution of crustaceans, a spatial feed insert distribution. The spatial feed distribution indicates one or more positions at a boundary of the volume and/or within the volume from which feed is to be inserted in the volume.

As already explained in the background section, a longer disintegration time of the feed (pellets) is advantageous in that it allows the feed to reach the bottom, which is where the shrimps are, and in that it increases the reach of the feed meaning that crustaceans further removed from the feed will be able to detect, reach and consume the feed pellets before the feed is completely disintegrated.

However, long disintegration times also pose a challenge as to where to position the feed. To illustrate, feed pellets may be inserted into the water at a first point in time. The pellets then sink to a particular volume on the bottom of for example a fish tank. Thereafter, at a second point in time, the pellets in that particular volume will have disintegrated to such degree that they can be consumed by crustaceans. Preferably, of course, many crustaceans will be present in the particular volume at the second point in time so that the feed pellets are actually consumed by the crustaceans as much as possible and so that as little feed as possible is wasted. However, even if many crustaceans are present in the particular volume at the time of inserting the feed pellets into the water, they may, and typically do, move, which may result in only few crustaceans in the particular volume at the second time. Therefore, it is sub-optimal to determine where, for example in which area of a fish tank, to provide feed pellets based on the positions of crustaceans at the time of feeding.

The inventors have recognized that predicting the positions of crustaceans at some future time allows to provide feed pellets such that they are consumable at the right time and in the right place, e.g. such that the feed pellets are in an area with many crustaceans when the pellets are actually (becoming) consumable. Hence, the methods and systems disclosed herein enable to reduce mortality due to insufficient feeding and increase the feeding efficiency, which may in turn lead to higher water qualities as the amount of non-consumed feed polluting the water is decreased.

As referred to herein, a spatial distribution of crustaceans within the volume, whether it is an actual or predicted spatial distribution, may be understood to indicate, for each sub-volume of a plurality of sub-volumes within the volume, a respective predicted density and/or amount of crustaceans at the future time. A current/predicted spatial distribution may thus indicate in which one or more sub-volumes of the volume relatively many crustaceans are/will be present, and in which one or more sub-volumes relatively few crustaceans are/will be present. The actual spatial distribution of crustaceans may be a current spatial distribution or a historical spatial distribution. It should be appreciated that typically the actual spatial distribution of crustaceans cannot be determined with 100% accuracy. Determining the actual spatial distribution may thus be understood as estimating the actual spatial distribution.

In an embodiment, the predicted spatial distribution indicates for at least one sub-volume of the plurality of sub-volumes a relatively high density, relative to one or more other, e.g. all other, predicted densities—as indicated by the predicted spatial distribution—for one or more other, e.g. all other, sub-volumes of the plurality of sub-volumes. Preferably, in this embodiment, feed, such as feed pellets, for the crustaceans are inserted into the volume in such manner that the inserted feed is, at the future time, in the at least one sub-volume accommodating relatively many crustaceans and is in a state in which the feed is consumable for crustaceans.

The volume is a three-dimensional volume and is typically filled with water in which the crustaceans are present. The spatial distribution may be three dimensional in the sense that it defines different sub-volumes along all three dimensions (X, Y, Z). In that case, the spatial distribution may thus indicate a varying density along each of the three spatial dimensions. However, the spatial distribution may also be two-dimensional in the sense that it defines different sub-volumes along only two dimensions, e.g. only along X- and Y-directions, not along a Z-direction. In an example, the XY-plane is parallel to the water surface and preferably also parallel to a bottom surface of the volume, and the Z-direction is perpendicular to the water surface. Such two-dimensional predicted spatial distribution may be usable as well if for example the crustaceans tend to remain substantially in a single plane, e.g. on the bottom surface of the volume.

The barriers referred to may be natural barriers and/or artificial barriers. Shrimps, for example, are typically grown in fish tanks.

The feed may be in the form of feed pellets that disintegrate while they are in contact with water. In such case, the method is especially beneficial because then there can be a significant amount of time between the insertion of the feed pellets into the volume and the moment that the feed pellets are consumable. To illustrate, it may take 60 to 120 minutes for feed pellets to disintegrate. Hence, it is advantageous to predict which sub-volumes in the volume will accommodate many crustaceans at the time that the feed pellets are consumable.

The methods disclosed herein are optionally computer-implemented methods.

Preferably, the spatial feed insert distribution also indicates when feed is to be inserted into the volume form the one or more positions. Of course, the spatial feed insert distribution may indicate different feeding times for different positions. However, the spatial feed insert distribution may also indicate one and the same feeding time for several, e.g. all, positions. Even further the spatial feed insert distribution may, for each position out of the one or more positions, indicate a plurality of feeding times.

In an embodiment, the future spatial distribution of crustaceans within the volume is determined based on a current and/or prior activity of crustaceans in the volume and/or based on current and/or prior feeding behavior of the crustaceans in the volume and/or based on a mobility of the crustaceans in the volume.

In an embodiment, the spatial feed insert distribution indicates a total amount of feed to be inserted into the volume.

Preferably, the spatial feed insert distribution indicates, for each position out of the one or more positions, an amount of feed that is to be inserted into the volume. This allows to tailor the amount of feed that is inserted such that an appropriate amount of feed is present in selected volumes at the future time.

Determining, for each sub-volume, the amount of feed may be performed based on a number of crustaceans in the sub-volume in question as indicated by the predicted spatial distribution and/or based on one or more characteristic values of crustaceans, preferably of crustaceans that are in the sub-volume in question as indicated by the predicted spatial distribution and/or based on one or more activity values of crustaceans, preferably of crustaceans that are in the sub-volume in question as indicates by the predicted spatial distribution.

This embodiment may comprise determining, based on the predicted spatial distribution of crustaceans, the appropriate amount of feed that is to be present in the at least one sub-volume accommodating relatively many crustaceans at the future time and determining, based on the determined appropriate amount of feed for the at least one sub-volume, the spatial feed insert distribution.

In an embodiment, the amount of feed that is to be inserted from each position out of the one or more positions, is determined based on a number of crustaceans in the volume and/or based on a size of crustaceans in the volume and/or based on starvation level of crustaceans in the volume and/or based on a feeding activity of crustaceans in the volume and/or based on a previously used feed disintegration time for feeding crustaceans and/or based on a previously measured feed conversion rate.

In an embodiment, the spatial feed insert distribution indicates, for each position out of the one or more positions, one or more properties of the feed that is to be inserted into the volume, such as a size of the feed pellets and/or such as a disintegration rate of the feed pellets and/or such as a disintegration time of the feed pellets. In this embodiment, it is not required that the spatial feed insert distribution indicates a single size/disintegration rate/disintegration time for each position. To illustrate, the spatial feed distribution may indicate, for each position, a size distribution/disintegration rate distribution/disintegration time distribution.

In an embodiment, the crustaceans belong to the superfamily Penacoidea, preferably from the families Aristeidae or Penaeidae, such as gamba shrimps and/or tiger prawns and/or whiteleg shrimps and/or Atlantic white shrimps and/or Indian prawns.

In an embodiment, the method comprises obtaining a sequence of images of the volume. Each image out of the sequence of images is associated with a different time. This embodiment also comprises determining, based on the sequence of images, a plurality of trajectories through the volume of a plurality of respective crustaceans. This latter step comprising, for each of the plurality of crustaceans,
detecting an image object in an image out of the sequence of images, the object representing the crustacean in question, and
tracking the object across several images out of the sequence of images in order to determine a trajectory of the crustacean in question through the volume.

This embodiment also comprises determining, based on the determined plurality of trajectories, the actual spatial distribution of crustaceans and/or predicting the future spatial distribution of crustaceans.

This embodiment allows to track individual shrimps and therefore provides great accuracy with which the actual spatial distribution can be determined.

The images in the sequency of images may represent only a part of the volume.

In an embodiment, the actual spatial distribution occurs at a first time before the future time. This embodiment further comprises determining a second actual spatial distribution of crustaceans within the volume. The second actual spatial distribution occurs at a second time before the future time, the second time being after the first time. In this embodiment, the prediction of the future spatial distribution of crustaceans is performed based on the determined actual spatial distribution and based on the determined second actual spatial distribution.

In particular, the future spatial distribution may be determined based on a difference between the actual spatial distribution and the second actual spatial distribution. To illustrate, the difference may indicate that populations or groups of crustaceans move in a certain direction through the volume. This allows to accurately predict the future spatial distribution without having to track individual crustaceans.

Such difference may not only indicate a direction of movement of groups or populations of shrimps, but also a speed with which they move through the volume.

In an embodiment, the method comprises determining, for one or more crustaceans in the volume, one or more characteristic crustacean values, each characteristic crustacean value indicating a property of one or more crustacean, such as weight, size, health status, moulting status, color appearance, starvation level, prior feed activity, age of one or more crustaceans. This embodiment also comprises determining, based on the determined one or more characteristic crustacean values, the spatial feed insert distribution.

In this embodiment, preferably, the spatial feed insert distribution indicates for each position out of the one or more positions, an amount of feed that is to be inserted into the volume and/or preferably indicates, for each position out of the one or more positions, one or more properties of the feed is to be inserted into the volume. The appropriate amount and/or properties of feed for a crustacean namely depends on the properties of the crustacean and may thus be determined based on the characteristic crustacean values. To illustrate, arthropods such as shrimps discard their old exoskeletons periodically and simultaneous build a new one in a process known as moulting. Litopenaeus vannamei a.k.a whiteleg shrimp is one of the most commonly farmed shrimp species in the world. L. vannamei has been known to moult every few days to weeks depending size, stage and treatment strategy. The moulting cycle of shrimp can be divided into four recurrent stages: inter-moult, pre-moult, the moment of the moulting behaviour/ecdysis and post-moult. The characteristic crustacean values may comprise moulting status values. A moulting status value referred to herein may be understood to indicate in which stage of the moulting cycle the crustacean is. For growth, L. vannamei need to shed and replace their old exoskeletons and synthesize a new one, and this process is frequently repeated during the life cycle. Failure of moulting in the metamorphosis and mortality of the moulting shrimps are two important reasons for production reduction in aquaculture. It has been known that shrimps exhibit significantly different locomotive and feeding behaviors during stages of moulting. For examples, during pre-moult stage shrimps slowly reduce feeding before completely stopping food intake. In contrast, feed and water intake ramps up significantly during post-moulting stage.

Determining one or more characteristic values may comprise capturing one or more crustaceans and measuring of each captured crustacean the one or more properties. Additionally or alternatively, determining one or more characteristic values may comprise recording one or more images of crustaceans that are present within the volume, and determining the properties of the crustaceans based on the one or more images. To illustrate, the size of crustaceans can be determined based on such images.

In an embodiment, the method comprises determining, for one or more crustaceans in the volume, one or more activity values, each activity value being indicative of how active one or more crustaceans are. This embodiment also comprises predicting, for the future time, the spatial distribution of the crustaceans within the volume based on the determined one or more activity values and/or determining the spatial feed insert distribution.

This embodiment improves the feeding efficiency as it allows to more accurately predict the future spatial distribution and to more accurately determine the appropriate spatial feed distribution.

In this embodiment, preferably, the spatial feed insert distribution indicates for each position out of the one or more positions, an amount of feed that is to be inserted into the volume and/or preferably indicates, for each position out of the one or more positions, one or more properties of the feed is to be inserted into the volume. The appropriate amount and/or properties of feed for a crustacean namely depends on how active the crustacean is and can thus be determined based on the one or more activity values. As used herein, a relatively highly active crustacean may be understood to move about vigorously or frequently, whereas a more passive crustacean may be understood to move about less vigorously or less frequently.

Determining the one or more activity values may comprise recording a sequence of images, each image being associated with a respective time. The sequence of image may show crustaceans moving about to more or lesser extent. Hence, the activity values may be determined based on such sequence of images.

In an embodiment, the method comprises performing a machine learning method for predicting, for the future time, the spatial distribution of crustaceans within the volume. The machine learning method comprises constructing a model based on training data. The training data associate sets of one or more input parameters relating to a third time, with respective actual spatial distributions of crustaceans within the volume at a fourth time. The fourth time is after the third time. The machine learning method also comprises measuring one or more input parameters relating to a time before the future time and using the constructed model for predicting on the basis of the measured one or more input parameters, the spatial distribution of crustaceans within the volume at the future time. The one or more input parameters comprise one or more determined actual spatial distributions of crustaceans. Preferably, the one or more input parameters also comprise:
a plurality of trajectories of respective crustaceans through the volume and/or
one or more activity values, each activity value being indicative of how active one or more crustaceans are, and/or
one or more characteristic crustacean values, each characteristic crustacean value indicating a property of one or more crustacean, such as weight, size, health status, moulting status, color appearance, starvation level, prior feed activity, age of one or more crustaceans.

This embodiment enables to predict the future spatial distribution of crustaceans fast and accurately.

Parameters relating to a particular time may be understood as the parameters describing a situation or status at the particular time, e.g. the activity values being indicative of how active one or more crustaceans are at the particular time.

In an embodiment, the method comprises performing a machine learning method for determining the spatial feed insert distribution. The machine learning method comprises constructing a second model based on second training data. The second training data associate sets of one or more second input parameters with respective spatial feed insert distributions and preferably also with a feed assessment value indicating how well and/or how efficient crustaceans were fed using the spatial feed insert distribution in question. The machine learning method also comprises measuring one or more second input parameters and using the constructed second model for predicting, based on the measured one or more input parameters, the spatial feed insert distribution. The one or more second input parameters comprise one or more actual spatial distributions of crustaceans and/or the predicted spatial distribution of crustaceans. Preferably, the one or more second input parameters also comprise:
a plurality of trajectories of respective crustaceans through the volume and/or
one or more properties of the feed pellets; and/or
one or more activity values, each activity value being indicative of how active one or more crustaceans are, and/or
one or more characteristic crustacean values, each characteristic crustacean value indicating a property of one or more crustacean, such as weight, size, health status, moulting status, color appearance, starvation level, prior feed activity, age of one or more crustaceans.

This embodiment allows to determine the appropriate spatial feed insert distribution fast and accurately.

Measuring a feed assessment value may indicate an amount of feed that is not consumed. In such case, a low amount of feed not consumed would correspond to crustaceans being fed quite well and/or efficient. However, it should be appreciated that the training data do not need to include feed assessment values. This is especially true if the training data only include sets of input parameters associated with spatial feed insert distributions that resulted in crustaceans being fed well and/or efficiently.

In an embodiment, the determined actual spatial distribution of crustaceans and the future spatial distribution of crustaceans distinguish between at least a first type and a second type of crustacean.

This allows to determine spatial feed insert distributions which are even more accurate. To illustrate, it may be that smaller crustaceans (will) sit in one region of the volume and that larger crustaceans (will) sit in another region of the volume. In such case, it may be beneficial to insert less feed for the one region and more feed for the other region (by inserting the feed from respective, appropriate positions into the volume).

The first type and second type of crustacean may differ with respect to any property, such as size, weight, color, activity value, moulting status, color appearance, starvation level, prior feed activity, age, species, et cetera. This embodiment preferably involves measuring certain characteristics of crustaceans in volume and consider them as a first type or second type based on these measured characteristics.

These distributions may distinguish between three types or even between more types of crustaceans.

In an embodiment, the method comprises causing insertion of feed into the volume in accordance with the spatial feed insert distribution.

As referred to herein, inserting feed into the volume in accordance with the spatial feed insert distribution may be understood as inserting feed into the volume from the one or more positions indicated by the spatial feed insert distribution and/or inserting, from each indicated position, the amount of feed as indicated by the spatial feed insert distribution and/or inserting, from each indicated position, feed having properties as indicated by the spatial feed insert distribution.

The predicted future spatial distribution of crustaceans may indicate regions in the volume where relatively high densities of crustaceans are present. In such case, preferably, the feed is inserted into the volume in such manner that the inserted feed is in these regions at the future time and in a state in which it is consumable for the crustaceans. In any case, preferably, the feed in inserted such that at the future time an appropriate amount of feed is present given the predicted spatial distribution and such that at the future time the feed is consumable, e.g. in the sense that feed pellets have disintegrated to such extent that the crustaceans can consume the feed.

In an embodiment in which one or more properties of feed to be inserted are determined, the method may comprise preparing the feed such that it has the desired properties and then inserting it into the volume in accordance with the spatial feed insert distribution. To illustrate, if relatively short disintegration times have been determined, then the method may comprise pretreating standard feed pellets such that they have a shorter disintegration time. Such pretreating may comprises illuminating feed pellets with light that causes partial disintegration of feed pellets. Feed pellets may additionally or alternatively be sensitized to make release speed of chemo-attractants from feed optimal for the desired chemotaxis (i.e. movement of the shrimp in response to the chemical stimulus) in monitored volume of water. Such, a pretreatment of feed may also include breaking down pellets from standard sizes to various sizes of optimal distribution for a given group of shrimps.

One aspect of this disclosure relates to a data processing system comprising a processor that is configured to perform any of the methods described herein. Preferably, the data processing system comprises an input interface for receiving input, such as images from one or more cameras as described herein. Preferably, the data processing system comprises an output interface for sending output to other systems, such as the feed system described herein.

One aspect of this disclosure relates to a system for feeding crustaceans that are present in a volume at least partially enclosed by one or more barriers for keeping the crustaceans in the volume. The system comprises a feed system for inserting feed into said volume from one or more positions at a boundary of the volume and/or within the volume. The system also comprises a data processing system comprising a processor that is configured to perform steps of
determining an actual spatial distribution of crustaceans within the volume, and
based on the determined actual spatial distribution, predicting, for a future time, a future spatial distribution of crustaceans within the volume, and
determining, based on the future spatial distribution of crustaceans, a spatial feed insert distribution, the spatial feed distribution indicating one or more positions at a boundary of the volume and/or within the volume from which feed is to be inserted in the volume, and
using the feed system, causing insertion of feed into the volume in accordance with the spatial feed insert distribution.

One aspect of this disclosure relates to a computer program comprising instructions which, when the program is executed by a computer, cause the above mentioned system for feeding crustaceans to carry out steps of
determining an actual spatial distribution of crustaceans within the volume, and
based on the determined actual spatial distribution, predicting, for a future time, a future spatial distribution of crustaceans within the volume, and
determining, based on the future spatial distribution of crustaceans, a spatial feed insert distribution, the spatial feed distribution indicating one or more positions at a boundary of the volume and/or within the volume from which feed is to be inserted in the volume, and
causing insertion of feed into the volume in accordance with the spatial feed insert distribution.

One aspect of this disclosure relates to a computer program comprising instructions which, when the program is executed by a computer, cause the computer to carry out any of the methods described herein.

One aspect of this disclosure relates to a computer-readable medium having stored thereon any of the computer programs disclosed herein.

One aspect of this disclosure relates to a computer comprising a computer readable storage medium having computer readable program code embodied therewith, and a processor, preferably a microprocessor, coupled to the computer readable storage medium, wherein responsive to executing the computer readable program code, the processor is configured to perform any of the methods described herein.

One aspect of this disclosure relates to a computer program or suite of computer programs comprising at least one software code portion or a computer program product storing at least one software code portion, the software code portion, when run a computer system, being configured for executing any of the methods described herein.

One aspect of this disclosure relates to a non-transitory computer-readable storage medium storing at least one software code portion, the software code portion, when executed or processed by a computer, is configured to perform any of the methods described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local volume network (LAN) or a wide volume network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1A illustrates a system according to an embodiment;

FIG. 1B is a flow chart illustrating a method according to an embodiment;

FIG. 2A schematically illustrates a determined actual spatial distribution of crustaceans;

FIG. 2B schematically illustrates yet another determined actual spatial distribution of crustaceans;

FIG. 2C illustrates a predicted future spatial distribution of crustaceans according to an embodiment;

FIG. 2D illustrates a spatial feed insert distribution according to an embodiment;

FIGS. 3A & 3B show actually determined spatial feed insert distributions according to respective embodiments;

FIG. 4A illustrates body segmentation of a crustacean as may be performed by machine learning algorithms according to an embodiment;

FIG. 4B illustrates a trajectory of a crustacean according to an embodiment;

FIG. 4C illustrates several trajectories through the volume according to an embodiment;

FIG. 4D is a histogram indicating activity per sub-volume;

FIG. 5 is a flow chart illustrating a machine learning method according to an embodiment;

FIG. 6 illustrates training data that can be used to train a machine learning algorithm for predicting the future spatial distribution according to an embodiment;

FIG. 7 illustrates training data that can be used to train a machine learning algorithm for determining an appropriate spatial feed insert distribution;

FIG. 8 illustrates a data processing system according to an embodiment.

### DETAILED DESCRIPTION OF THE DRAWINGS

In the figures, identical reference number indicate identical or similar elements.

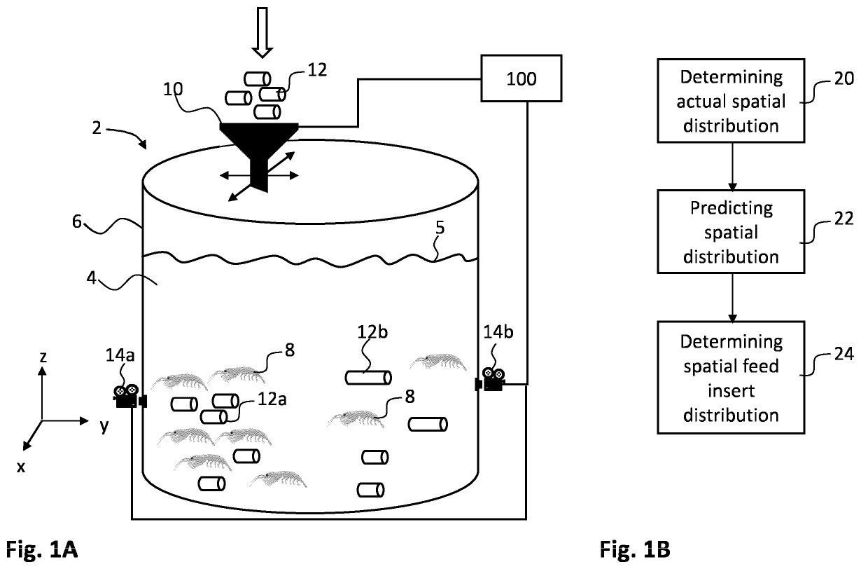

FIG. 1A schematically illustrates a volume 4 that is at least partially enclosed by one or more barriers 4. In the depicted embodiment, the barriers 6 are the side walls of a fish tank 2. Crustaceans 8 are present in volume 4. The volume 4 may be understood as the water volume 4 in which the crustaceans 8 can move freely. Thus, the water surface 7 may be understood to define a boundary of the volume 4. The crustaceans for example belong to the superfamily of prawns Penaeoidea, preferably from the families Aristeidae or Penaeidae, such as such as gamba shrimps and/or tiger prawns and/or whiteleg shrimps and/or Atlantic white shrimps and/or Indian prawns.

FIG. 1A in particular illustrates a system for feeding crustaceans 8, wherein the system comprises a feed system 10 that can insert feed 12 into the volume 4 from one or more positions at a boundary of the volume and/or within the volume. Preferably, the feed system 10 is configured to control from which positions the feed 12 is inserted into volume 4 so that the feed can be inserted into volume 4 in accordance with various spatial feed insert distributions. To this end, for example, the feed system 10 may comprise a food providing element that is configured to provide feed 12 and that is movable relative to volume 4 (as indicated by the double arrows in FIG. 1A).

The feed 12 that is provided to the crustaceans 8 may be in the form of feed pellets. The feed 12 need not have uniform properties. One part of the feed may for example be formed by relatively large pellets 12b, whereas another part of the feed may for example be formed by relatively small pellets 12a.

FIG. 1 also shows a data processing system 100. The data processing system 100 is configured to determine spatial feed distributions in accordance with methods described herein. Preferably, the data processing system 100 is configured to control the feed system 10, if such feed system 10 is present, that is. The data processing for example may cause insertion of feed in accordance with a spatial feed insertion distribution by sending appropriate control signals to the feed system 10.

Optionally, the system for feeding crustaceans also comprises a camera 14. The system depicted in FIG. 1A comprises a plurality of cameras 14a and 14b. Each camera 14 is then configured to capture video of part of the volume 4. Capturing a video may be understood to involve obtaining a sequence of images of the volume 4, wherein each image out of the sequence of images is associated with a different time. Preferably, each camera provides the video that it captures to the data processing system 100 so that the data processing system 100 can determine relevant parameters based on the captured video(s).

The data processing system 100 may for example be configured to determine trajectories of crustaceans 8 in order to determine an actual spatial distribution of crustaceans and/or a predicted spatial distribution of crustaceans and/or an activity value indicating how active one or more crustaceans are.

FIG. 1B is a flow chart illustrating a method according to an embodiment. Such method may for example be performed by data processing system 100 in which case the method may be understood to be a computer-implemented method.

The method comprises a step 20 of determining an actual spatial distribution of crustaceans within the volume. This step may be performed in various ways. The data processing system may for example determine an actual spatial distribution based on videos of the volume 4 as captured by one or more cameras 4.

The method also comprises a step 22 of predicting, for a future time, based on the determined actual spatial distribution, a future spatial distribution of crustaceans within the volume. This step may also be performed in various ways. One way for example comprises performing a machine learning method, which comprises constructing a model based on training data.

Of course, the future spatial distribution may also be predicted based on a measured direction of movement and/or speed of one or more crustaceans. Determining a direction of movement and/or speed may be performed based on video data as captured by the one or cameras 14. Additionally or alternatively, determining the direction of movement and/or speed may be performed based on two determined actual spatial distributions of crustaceans, one at a first time and another at a second time. The two spatial distributions may differ from each other and may therefore indicate direction of movement and/or speed of groups or populations of crustaceans.

Step 24 comprises determining, based on the future spatial distribution of crustaceans, a spatial feed insert distribution. The spatial feed distribution indicates one or more positions at a boundary of the volume and/or within the volume from which feed is to be inserted in the volume. It should be appreciated that data that indicate in which sub-volumes of volume 4 feed should be present at the future time, may be understood as indicating from which one or more positions the feed should be inserted. After all, typically, there is a quite simple relationship between where feed should be present in the volume and from which position(s) feed should be inserted into the volume 4. Usually, if feed is to be present in a certain sub-volume of volume 4 at the particular time, then some time before the future, the feed can be inserted into the volume from a position at the water surface above said certain sub-volume.

The method optionally comprises causing insertion of feed into the volume in accordance with the spatial feed insert distribution, for example by sending appropriate control instructions to a feed system 10.

One or more characteristic values of crustaceans in the volume may be measured, wherein each characteristic value indicates a property of one or more crustaceans, such as weight, size, health status, moulting status. Each characteristic value may relate to a single crustaceans, however, the characteristic value may also relate to a plurality of crustaceans, e.g. in the case the value is some average value, e.g. an average weight of the crustaceans. Based on the determined characteristic one or move values can the spatial feed insert distribution be determined. Such values may be used to determine an amount of feed to be inserted into volume 4 from each position and/or to determine one or more properties of the feed that is to be inserted into the volume 4. To illustrate, if the one or more characteristic values indicate that the crustaceans 8 in the volume 4 are relatively large, then higher amounts of feed may be determined for each position so that the crustaceans receive sufficient feed.

Additionally or alternatively, one or more activity values may be measured. Herein, each activity value is indicative of how active one or more crustaceans are. This is for example advantageous for determining the spatial distribution. After all, if the crustaceans 8 are more active, they tend to move more vigorously through the volume 4. The predicted future spatial distribution may in such case be quite different from the determined actual spatial distribution. On the other hand, if the crustaceans 8 are less active, then the predicted future spatial distribution may be more similar to the determined actual spatial distribution.

If one or more activity values are measured, then the future spatial distribution and/or the spatial feed insert distribution may be determined based on the one or more activity values.

For measuring the actual spatial distribution of crustaceans, the cameras 14 may be used. Each camera 14 may capture one or more images of at least a part of the volume. Subsequent image analysis may then yield the actual spatial distribution. In an example, a human operator can count the number of crustaceans that are visible in one or more images of one or more sub-volumes of the volume in order to estimate the number of crustaceans in different sub-volumes thus estimating the actual spatial distribution. In another example, image machine learning algorithms have been trained to recognize (images of) crustaceans in images as captured by a camera 14. This allows to automatically count a number of crustaceans in an image and thus to count the number of crustaceans in different sub-volumes in the volume 4 at some point in time, thus determining the actual spatial distribution of crustaceans. Additionally or alternatively, images may be analyzed using more classical, i.e. non machine-learning, algorithms. Such classical algorithms may for example cause a data processing system to estimate a number of crustaceans in an image by analyzing a color histogram of the image in question. Crustaceans may appear as light in an image, whereas the background may be darker. In such case, more bright pixels—as indicated by such histogram—would correspond to more crustaceans being visible in the image.

In any case, it should be appreciated that, if image analysis is used for determining the actual spatial, it is not required that the entire volume is imaged. A representative number of sub-volumes, at selected locations within the volume can be used.

Additionally or alternatively, determining the actual spatial distribution may comprise taking a sample from respective sub-volumes in the volume, e.g. by using respective fishing nets configured to capture crustaceans in respective, selected and representative, sub-volumes. For each sample, the number of captured crustaceans is indicative of the number of crustaceans that are present in the sub-volume from which the sample in question was taken. Hence, the actual spatial distribution can be estimated. The cameras 14 may also be used for determining, e.g. measuring, the one or more characteristic values and/or the one or more activity values. Again, machine learning algorithms may have been trained to determine characteristics, such as weight, size, color, based on images as captured by cameras 14. Further, activity values may also be determined based on such images. Preferably, activity values are determined based on a movie as captured by the one or more cameras so that the movement of crustaceans, and the degree of movement of crustaceans can be derived from the captured images.

Sampling of crustaceans out of volume 4 may also be performed for determining one or characteristic values of crustaceans. This may comprise simply taking out a number of crustaceans out of volume 4 and measuring the one or more characteristic values as present in these crustaceans.

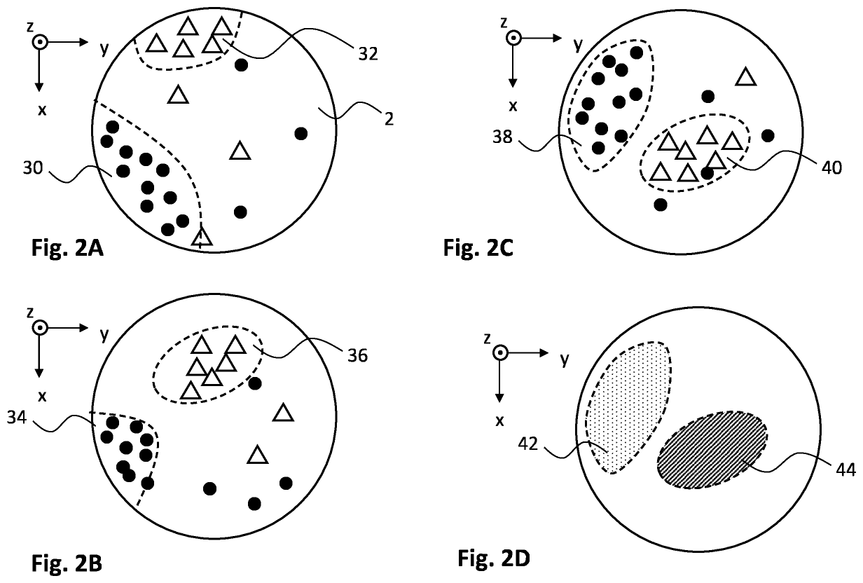

FIG. 2A is a schematic illustration of a determined actual spatial distribution. The depicted actual spatial distribution is a two-dimensional spatial distribution in that it only shows variation of crustacean density in two dimensions, namely X and Y, i.e. the directions parallel to the water surface, and no variation in the Z-direction, i.e. the direction perpendicular to the water surface.

The actual spatial distribution shows data points, namely solid dots and empty triangles, which represent a number of crustaceans at the XY position in question. Thus, regions with a high density of data points correspond to regions of high densities of crustaceans in the actual volume 4. The depicted actual spatial distribution distinguishes between crustaceans of a first type, represented by the solid dots, and crustaceans of a second type, represented by the empty triangles. The first type and second type may be distinguished from each other based on one or more properties of the crustaceans. To illustrate, relatively large crustaceans may be regarded as first type crustaceans, whereas relatively small crustaceans may be regarded as second type crustaceans. FIG. 2A for example shows that crustaceans of the first type are gathered in a region 30 in volume 4, whereas second type crustaceans are gathered in a region 32 of volume 4.

Of course, any spatial distribution of crustaceans described herein may distinguish between more types of crustaceans, for example, at least three types, at least four types, at least five types, et cetera.

FIG. 2A may be the actual spatial distribution at a first time before the future time. However, preferably, the method for determining a spatial feed insert distribution also comprises determining, e.g. measuring, a spatial distribution of crustaceans at a second time before the future time, yet after the first time. FIG. 2B schematically shows such second actual spatial distribution which follows the actual spatial distribution of FIG. 2A.

FIG. 2B illustrates that the crustaceans of the first type have concentrated in a region 34 different from 30 and that the crustaceans of the second type have concentrated in a region 36 different from region 32. It thus appears that the first type crustaceans are moving in the −X direction, whereas the second type crustaceans are moving in the +X direction, roughly speaking.

FIG. 2C illustrates a future spatial distribution of crustaceans within the volume 4, which is predicted based on the actual spatial distribution of FIG. 2A. Optionally, the second actual distribution of FIG. 2B was also taken into account in the prediction of the future spatial distribution of FIG. 2C. However, this is not per se required.

The future spatial distribution of FIG. 2C indicates that the first type of crustaceans will be, at a future time, primarily in region 38, and that the second type crustaceans will be, at the future time, primarily in region 40.

The future time is for example 60-120 minutes after the first time (FIG. 2A) or after the second time (FIG. 2B).

FIG. 2D illustrates a spatial feed insert distribution that is determined based on the future spatial distribution shown in FIG. 2C. The spatial feed insert distribution indicates that a first type of feed, and a first amount of feed is to be inserted from the area 42 on the water surface of the volume 4, and that a second type of feed, and a second amount of feed is to be inserted from the area 44 on the water surface of the volume 4. The areas 42 and 44 may be understood as positions from which feed is to be inserted into volume 4. Feeding in accordance with the spatial feed insert distribution of FIG. 2d can be performed by simply dropping feed pellets in area 42 resp. 44 on the water surface, after which the feed pellets will sink into the volume 4. It should be appreciated that the first type of feed and the second type of feed may or may not be the same. It should be appreciated that the first amount and second amount of feed may or may not be the same.

Also, the spatial feed insert distribution may indicate for each position, e.g. area, out of a plurality of positions one or more times at which feed is to be inserted into volume 4 via the position, e.g. area, in question. Further, the spatial feed insert distribution may indicate, for each feed time, an amount of feed and/or one or more properties of the feed.

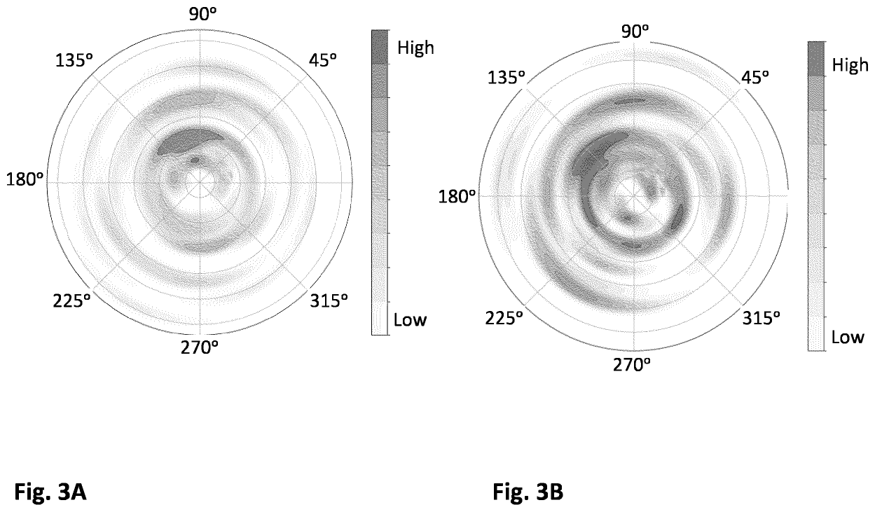

FIGS. 3A and 3B show actually determined spatial feed insert distributions according to respective embodiments. Herein, darker areas correspond to sub-volumes accommodating higher densities of crustaceans.

By fusing sensory data from plurality of sensors underwater and outside water, activity of shrimp(s) in the volume 4 (e.g. tank) can be detected and tracked and stored in a database, e.g. for use as training data. Using such current and historical data points as timeseries, it is possible to generate an activity map of shrimp. Kalman filter or SURF estimation can be used to understand the distribution of crustaceans in the volume over time and forecast movement of crustaceans with time to generate a 3D probability distribution of crustaceans movement over time. With the outputs from crustaceans detection and their activity forecasting as parameters to a nonlinear model such as a simple Artificial Neural Network or a Recurrent Neural Network which can take into temporal parameters such as the amount of feed ped into each area and amount of feed eaten by crustaceans in each area it is possible to generate a guidance for where and when to drop the feed along with the amount of feed required to drop into the volume from each area.

Using prior information on crustacean feeding activity and locomotive activity, it is possible to estimate probability of feeding success rate F for a segment S_((x,y)) at bottom surface of a tank using Bayesian estimation method as follows:

$$P ( F \vert S\_ ( ( x , y ) ) ) ∝ P ( S\_ ( ( x , y ) ) \vert F ) * P ( F )$$

where P(S_((x,y))|F)* is the posterior probability of spatial cell S_((x,y)) given the observation of feeding success and P(F) is the prior probability of feeding success. Similar techniques can be applied to generate recommendations of following for a given spatial cell S_((x,y)): feed volume, size of pellets and optimal disintegration time of feed underwater.

In embodiment, the method comprises obtaining a sequence of images of the volume, wherein each image out of the sequence of images is associated with a different time. This step can be performed by recording a video of at least a part of the volume 4. The sequence of images allows to determine trajectories through the volume of crustaceans.

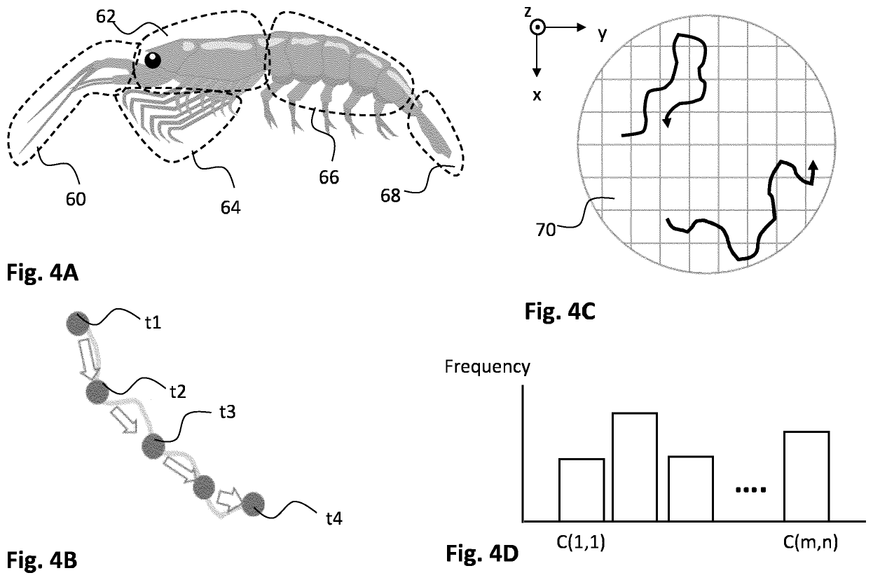

Determining a trajectory for example involves detecting an image object in an image out of the sequence of images, the object representing a crustacean. To this end, suitable image recognition techniques may be employed. In an example, a neural network is used for detecting image objects representing crustaceans, for example by detecting one or more parts of crustaceans. FIG. 4A illustrates the different part of a crustaceans, shrimp. Herein, 60 indicates the antenna, 62 the head, 64 the legs, 66 the abdomen and 68 the tail of the shrimp.

The image object may then be tracked across several images out the sequence as illustrated in FIG. 4B. FIG. 4B illustrates a position of a detected image object in three different images out of a sequence of images, thus illustrates the position of a crustacean at four different times t1, t2, t3, t4. This allows to determine the trajectory for that crustaceans.

An array of sensors under water may be employed. In one embodiment, stereo vision cameras with adaptive lenses and color filters are fit inside a shrimp tank with coverage of entire volume 4 of water. The sensory data (e.g. images) may be first normalized and then fed into a pre-trained neural network which detects and quantifies shrimps and their activities and/or properties. In one embodiment, a backbone part of the network is instantiated from a popular object detection architecture (such as Resnet, Xception) and is leveraged via transfer learning. Custom layers may be built and objective functions to adapt aforementioned neural networks to the given problem. The output of one of the proposed algorithms includes (1) physical size of entire shrimp and shrimp body parts (eyes, walking legs, swimming legs, antennae, abdomen sections etc. (2) Physical properties of shrimps (shape, color etc.) and (3) current location of shrimps.

One or more properties of crustaceans may also be determined based on images as captured by cameras. To illustrate, based on the body part segmentation described above, the molting status and health status can be determined. For example, current molting status of a shrimp or group of shrimps can be evaluated based on relative age, relative locomotive activity (e.g. ratio of durations with low and high movement, antenna swipes etc.), relative feeding activity (e.g. volume of feeding, time spent feeding, approaching time to feed etc.), prior information on moulting events (count, duration etc.), shrimp's action of avoiding light, amount of exoskeletons in water and on tank's floor, coloration of abdomen sections, and relative size of morphological features (e.g. width of a white strip between head and abdomen).

FIG. 4C illustrates two trajectories (the solid lines in FIG. 4C) as determined for two different crustaceans during some time period. The determined trajectories in FIG. 4C area shown from a top view. It should be appreciated however, that the trajectories can also be measured in three dimensions.

FIG. 4C, together with FIG. 4D, also illustrates how an actual spatial distribution and/or activity values can be determined based on the found trajectories. FIG. 4C shows that the volume 4 may divided into sub-volumes, or sub-areas, 70. Then, for each sub-volume, the number of trajectories present in the sub-volume in question at some time instance, can be determined, which may be regarded as a direct measure of the actual spatial distribution as occurring at said time instance. Additionally or alternatively, the determining the actual spatial distribution may comprises monitoring, for each sub-volume, for some time period how many trajectories pass through the sub-volume in question. This may be regarded as a measure of the actual spatial distribution at some time in or near said time period.

Further, determined trajectories are also very suitable for determining one or more activity values of crustaceans. FIG. 4D is a histogram illustrates, for each sub-volume C(1,1) to C(m,n), how many trajectories have entered and exited the sub-volume in question, thus have passed through the sub-volume in question. A crustacean having entered and exited a sub-volume may namely be indicative of activity, whereas a crustacean having only entered a sub-volume during the time period or having only exited a sub-volume during the time period may be indicative of activity to a lesser extent.

Based on the histogram of FIG. 4D, one or more activity values may be determined. In an example, one activity value for each crustacean may be determined. Alternatively, some average activity value is determined for all crustaceans. Also, it is possible to determine an activity value for each of a plurality of groups of several crustaceans.

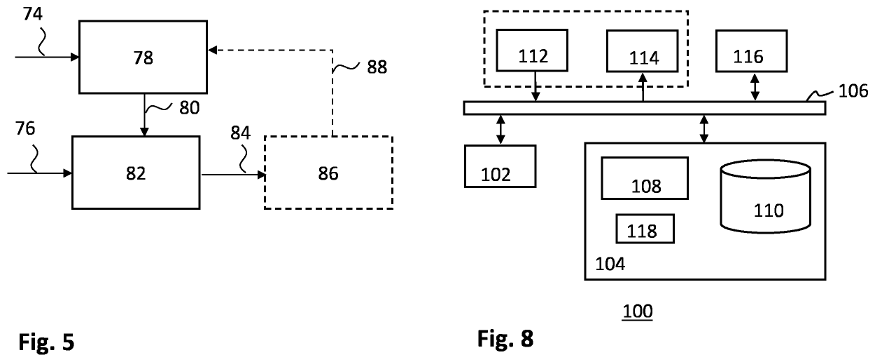

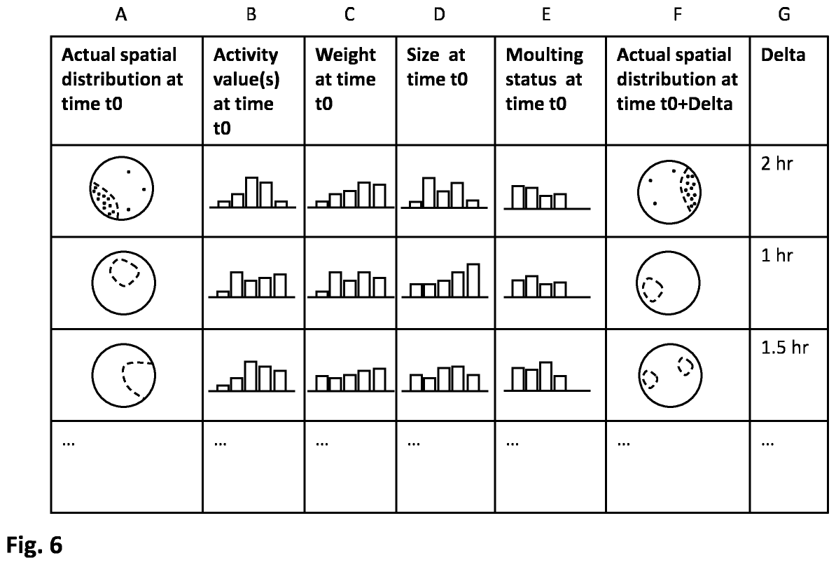

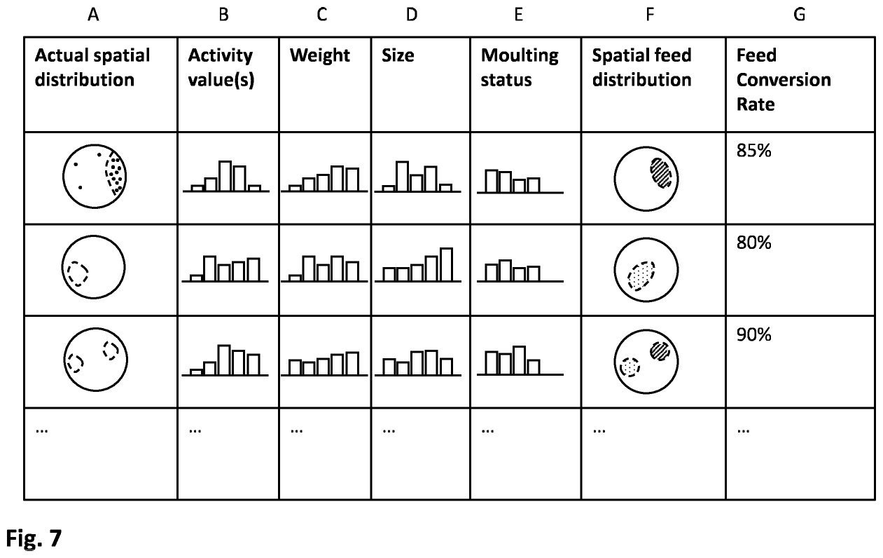

FIG. 5 illustrates how machine learning methods may be employed for predicting the future spatial distribution and/or the spatial feed insert distribution. In step 78 a model 80 is constructed based on training data 74. FIGS. 6 and 7 illustrate examples of such training data 74. The model 80 is then used in a step 82 which comprises determining, based on one or more measured input parameters 76, an output 84, which may the future spatial distribution at the future time and/or the spatial feed insert distribution. The input parameters may be measured using a network of connected sensors, such as photosensor, audio sensor, imager etc.) in a continuous fashion.

Preferably, a step 86 is performed of measuring an actual spatial distribution at the future time. This allows a comparison between the future spatial distribution as predicted for the future time by the machine learning method in step 82 and the actual spatial distribution at the future time. The determined actual spatial distribution at the future time 88 can then be fed back to step 78 in order to update the model 80 which is used for predicting the future spatial distribution.

Additionally or alternatively, if the machine learning method is used for determining the spatial feed insert distribution, then the optional step 80 may comprise measuring an effectiveness of the spatial feed insert distribution as determined in step 82. This may be performed by measuring how much feed is not consumed, for example. An indication of this effectiveness score 88 may then be fed back to step 78 in order to update the model, e.g. improve the model 80 that is used for determining the spatial feed insert distribution based on input parameters 76.

FIG. 6 illustrates training data that can be used to train a machine learning algorithm, i.e. data that can be used to construct a model for predicting a future spatial distribution of crustaceans. The training data associate sets of one or more input parameters relating some time t0 (columns A-E), with respective actual spatial distributions of crustaceans within the volume occurring at a later time t0+Delta (see columns F+G). In the figure, the data entries in one row are associated with each other. The training data are preferably relate to actual parameters in the sense that the training data only describe situation that have actually occurred.

In the depicted embodiment, the input parameters relating to time t0 of each row comprise:
the actual spatial distribution of crustaceans at time t0 (column A);
one or more activity values at time to, each activity value being indicative of how active one or more crustaceans are (column B);
one or more characteristic crustacean values, each characteristic crustacean value indicating a property of one or more crustacean at time to, in this case indicating weight (column C), size (column D), and moulting status (column E) of one or more crustaceans at time to. Of course, a plurality of trajectories of crustaceans around time t0 may also be included in the training data.

These one or more input parameters are associated with an actual spatial distribution at time t0+Delta (column F), wherein Delta may be different for each row as indicated by column G.

Preferably, of course, the input parameters 76 used to predict the future spatial distribution with the model are the same as the input parameters in the training data.

FIG. 7 illustrates training data that can be used to train a machine learning algorithm, i.e. data that can be used to construct a model for determining an appropriate spatial feed insert distribution. The training data associate sets of one or more input parameters (columns A-E) with respective spatial feed insert distributions (column f) and preferably also with a feed assessment value (column G) indicating how well and/or how efficient crustaceans were fed using the spatial feed insert distribution shown in column F. The training data are preferably relate to actual parameters in the sense that the training data only describe situation that have actually occurred.

The input parameters for each row comprises:
an actual spatial distributions of crustaceans (column A);
one or more activity values (column B), each activity value being indicative of how active one or more crustaceans are;
one or more characteristic crustacean values, each characteristic crustacean value indicating a property of one or more crustacean, in this case weight (column C), size (column D), moulting status (column E) of one or more crustaceans.

In an embodiment, the spatial feed insert distribution as defined in the training data (column F) also specify, for each position out of a plurality of positions at a boundary of the volume and/or within the volume, one or more properties of the feed, such as feed pellet size, feed disintegration time and/or an amount of feed.

The training data may also include measured trajectories as described herein.

Preferably, of course, the input parameters 76 used to predict the future spatial distribution with the model are the same as the input parameters in the training data. It should be appreciated, however, that a predicted spatial feed insert distribution, as predicted using e.g. machine learning methods described herein, may of course serve as input parameter for the model that determines the appropriate spatial feed insert distribution.

FIG. 8 depicts a block diagram illustrating a data processing system according to an embodiment.

As shown in FIG. 8, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, one or more cameras 14, one or more sensor as described herein, or the like. Examples of output devices may include, but are not limited to, a monitor or a display, speakers, a feed system as described herein, or the like. Input and/or output devices may be coupled to the data processing system either directly or through intervening I/O controllers.

In an embodiment, the input and the output devices may be implemented as a combined input/output device (illustrated in FIG. 8 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 8, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 8) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A computer-implemented method for determining a spatial feed insert distribution for feeding crustaceans that are present in a volume at least partially enclosed by one or more barriers for keeping the crustaceans in the volume, the method comprising:
determining by a processor, based on images from one or more cameras, an actual spatial distribution of crustaceans within the volume,
determining by the processor, based on images from one or more cameras, for one or more crustaceans in the volume, one or more activity values, each activity value being indicative of how active one or more crustaceans are in terms of movement of the one or more crustaceans, and
based on the determined actual spatial distribution and the determined activity values, predicting by the processor, for a future time, a future spatial distribution of crustaceans within the volume, and
determining by the processor, based on the future spatial distribution of crustaceans, a spatial feed insert distribution, the spatial feed distribution indicating one or more positions at a boundary of the volume and/or within the volume from which feed is to be inserted in the volume by a feed system.

2. The method according to claim 1, wherein the spatial feed insert distribution indicates, for each position out of the one or more positions, an amount of feed that is to be inserted into the volume.

3. The method according to claim 1, wherein the spatial feed insert distribution indicates, for each position out of the one or more positions, one or more properties of the feed that is to be inserted into the volume, such as a size of the feed pellets and/or such as a disintegration rate of the feed pellets and/or such as a disintegration time of the feed pellet.

4. The method according to claim 1, wherein the crustaceans belong to the superfamily Penaeoidea, preferably from the families Aristeidae or Penaeidae, such as such as gamba shrimps and/or tiger prawns and/or whiteleg shrimps and/or Atlantic white shrimps and/or Indian prawns.

5. The method according to claim 1, further comprising:
obtaining a sequence of images of the volume, wherein each image out of the sequence of images is associated with a different time,
determining, based on the sequence of images, a plurality of trajectories through the volume of a plurality of respective crustaceans, this step comprising, for each of the plurality of crustaceans,
detecting an image object in an image out of the sequence of images, the object representing the crustacean in question, and
tracking the object across several images out of the sequence of images in order to determine a trajectory of the crustacean in question through the volume, wherein
the method further comprises based on the determined plurality of trajectories, determining the actual spatial distribution of crustaceans and/or predicting the future spatial distribution of crustaceans.

6. The method according to claim 1, wherein
the actual spatial distribution occurs at a first time before the future time, the method further comprising:
determining a second actual spatial distribution of crustaceans within the volume, the second actual spatial distribution occurring at a second time before the future time, the second time being after the first time, wherein
predicting the future spatial distribution of crustaceans is performed based on the determined actual spatial distribution and based on the determined second actual spatial distribution.

7. The method according to claim 1, further comprising:
determining, for one or more crustaceans in the volume, one or more characteristic crustacean values, each characteristic crustacean value indicating a property of one or more crustacean, such as weight, size, health status, moulting status, color appearance, starvation level, prior feed activity, age of one or more crustaceans, and
based on the determined one or more characteristic crustacean values, determining the spatial feed insert distribution.

8. The method according to claim 1, wherein determining the one or more activity values may comprise recording a sequence of images, each image being associated with a respective time, the sequence of image showing crustaceans moving about to a more or lesser extent.

9. The method according to claim 1, further comprising performing a machine learning method for predicting, for the future time, the future spatial distribution of crustaceans within the volume, the machine learning method comprising:
constructing a model based on training data, the training data associating sets of one or more input parameters relating to a third time, with respective actual spatial distributions of crustaceans within the volume at a fourth time, the fourth time being after the third time, and
measuring one or more input parameters relating to a time before the future time, and
using the constructed model for predicting on the basis of the measured one or more input parameters, the spatial distribution of crustaceans within the volume at the future time, wherein
the one or more input parameters comprise:
one or more determined actual spatial distributions of crustaceans, and wherein, preferably, the one or more input parameters comprise:
a plurality of trajectories of respective crustaceans through the volume and/or
one or more activity values, each activity value being indicative of how active one or more crustaceans are, and/or
one or more characteristic crustacean values, each characteristic crustacean value indicating a property of one or more crustacean, such as weight, size, health status, moulting status, color appearance, starvation level, prior feed activity, age of one or more crustaceans.

10. The method according to claim 1, further comprising performing a machine learning method for determining the spatial feed insert distribution, the machine learning method comprising:
constructing a second model based on second training data, the second training data associating sets of one or more second input parameters with respective spatial feed insert distributions and preferably also with a feed assessment value indicating how well and/or how efficient crustaceans were fed using the spatial feed insert distribution in question, and
measuring one or more second input parameters, and
using the constructed second model for predicting, based on the measured one or more second input parameters, the spatial feed insert distribution, wherein
the one or more second input parameters comprise:
one or more actual spatial distributions of crustaceans and/or
the predicted spatial distribution of crustaceans, wherein preferably, the one or more second input parameters comprise
a plurality of trajectories of respective crustaceans through the volume and/or
one or more properties of the feed pellets and/or
one or more activity values, each activity value being indicative of how active one or more crustaceans are, and/or
one or more characteristic crustacean values, each characteristic crustacean value indicating a property of one or more crustacean, such as weight, size, health status, moulting status, color appearance, starvation level, prior feed activity, age of one or more crustaceans.

11. The method according to claim 1, wherein
the determined actual spatial distribution of crustaceans and the future spatial distribution of crustaceans each distinguish between a spatial distribution of crustaceans of at least a first type and a second type of crustacean.

12. The method according to claim 1, further comprising causing insertion of feed into the volume in accordance with the spatial feed insert distribution.

13. A data processing system comprising:
an input interface for receiving images from one or more cameras;
an output interface for sending control signals to a feeding system; and
a processor that is configured to perform the method according to claim 1.

14. A system for feeding crustaceans that are present in a volume at least partially enclosed by one or more barriers for keeping the crustaceans in the volume, the system comprising:
a feed system for inserting feed into said volume from one or more positions at a boundary of the volume and/or within the volume, and
the data processing system according to claim 13.

15. A non-transitory computer readable medium comprising instructions which, when the instructions are executed by a processor of the data processing system, cause the data processing system to perform the method of claim 1.
